(19) United States
(12) Patent Application Publication
(10) Pub. No.: US 2006/0198054 A1
(43) Pub. Date: Sep. 7, 2006

(54) FLEXIBLE TYPE UNIT, FLEXIBLE TYPE REEL, AND METHOD OF MANUFACTURING FLEXIBLE TYPE REEL

(75) Inventor: Se Joon YOU, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/276,572

(22) Filed: Mar. 6, 2006

(30) Foreign Application Priority Data
Mar. 7, 2005 (KR) 1020050018893

(51) Int. Cl. G11B 23/03

(52) U.S. Cl. 360/133

(57) ABSTRACT

The present invention includes a dummy layer formed between flexible type units. Accordingly, the strength can be increased during the punching process, an amount of a film can be reduced and the failure of the flexible type units can be prevented.

### CROSS-REFERENCES TO RELATED APPLICATIONS

This Nonprovisional application claims priority under 35 U.S.C. § 119(a) on Patent Application No. 10-2005-0018893 filed in Korea on Mar. 7, 2005 the entire contents of which are hereby incorporated by reference.

### BACKGROUND OF THE INVENTION

1. Field of the Invention

The present invention relates to a flexible type unit, a flexible type reel and a method of manufacturing the flexible type reel.

2. Background of the Related Art

Recently, a driver IC package used in flat display panels such as a Plasma Display Panel (PDP) and a Liquid Crystal Display (LCD) is a Chip on Film (COF) or a Tape Carrier Package (TCP) unit. The COF unit and the TCP unit have been widely used in flat display panels having a small thickness since they are flexible. The flexible type units such as the COF unit and the TCP unit are formed by punching a flexible type reel.

FIG. 1 is a plan view of a general flexible type reel.

As shown in FIG. 1, the general flexible type reel has flexible type units 101 formed on a film 100. Each of the flexible type units 101 is separated from the flexible type reel by a punching process and is then thermally compressed onto a display panel. In the general flexible type reel, transfer holes 102 are formed along both ends of the film 100.

The flexible type unit 101 has a drive IC 103 that generates a driving signal in response to a control signal. Electrode lines 104 for transmitting the control signal to the drive IC 103 and transmitting the driving signal to the display panel are formed in the flexible type unit 101.

To save the manufacturing cost necessary to produce the general flexible type reel, the amount of the film of the flexible type reel must be reduced. To reduce the amount of the film, it is necessary to narrow a distance (L1) between one flexible type unit 101a and the other flexible type unit 101b adjacent to the flexible type unit 101a.

If the distance (L1) between one flexible type unit 101a and the other flexible type unit 101b is too small, the film between one flexible type unit 101a and the other flexible type unit 101b may be torn during the punching process for separating one flexible type unit 101a from the flexible type reel. This may result in failure such as the destruction of the adjacent flexible type unit 101b.

### SUMMARY OF THE INVENTION

Accordingly, an object of the present invention is to solve at least the problems and disadvantages of the background art.

An embodiment of the present invention relates to a flexible type unit, a flexible type reel and a method of manufacturing the flexible type reel in which the amount of a film can be reduced.

Another embodiment of the present invention relates to a flexible type unit, a flexible type reel and a method of manufacturing the flexible type reel in which the failure of the flexible type unit can be prevented while reducing an amount of a film.

A flexible type reel according to an embodiment of the present invention comprises a plurality of flexible type units, each comprising a conductive layer formed on a film, for transmitting a driving signal to a display panel, and a dummy layer formed on the film between the flexible type units.

A method of manufacturing a flexible type reel according to an embodiment of the present invention comprises preparing a film, forming a conductive layer on the film, forming an electrode line by developing the conductive layer, and forming a dummy layer on the film.

The flexible type unit according to an embodiment of the present invention comprises the electrode lines formed on the film, for transmitting the driving signal to the display panel, and the dummy layer formed at least a portion of the film. The flexible type unit is formed by punching the flexible type reel manufactured by the manufacturing method according to an embodiment of the present invention.

In accordance with a flexible type unit, a flexible type reel and a method of manufacturing the flexible type reel according to an embodiment of the present invention, the manufacturing cost of the flexible type reel can be saved by reducing an amount of a film.

In accordance with a flexible type unit, a flexible type reel and a method of manufacturing the flexible type reel according to another embodiment of the present invention, the failure of the flexible type unit can be prevented while reducing an amount of a film.

### BRIEF DESCRIPTION OF THE DRAWINGS

The embodiment of the invention will be described in detail with reference to the following drawings in which like numerals refer to like elements.

FIG. 1 is a plan view of a general flexible type reel;

FIG. 2 is a plan view of a flexible type reel according to an embodiment of the present invention;

FIG. 3a is a cross-sectional view of the TCP unit included in the flexible type reel 150 according to an embodiment of the present invention;

FIG. 3b is a cross-sectional view of the TCP unit included in the flexible type reel 150 according to an embodiment of the present invention; and

FIGS. 4a to 4i are views illustrating a method of manufacturing the flexible type reel according to an embodiment of the present invention.

### DETAILED DESCRIPTION OF SPECIFIC EMBODIMENTS

Specific embodiments of the present invention will be described in a more detailed manner with reference to the drawings.

A flexible type reel according to an embodiment of the present invention comprises a plurality of flexible type units, each comprising a conductive layer formed on a film, for transmitting a driving signal to a display panel, and a dummy layer formed on the film between the flexible type units.

The dummy layer may comprise a conductive material.

The dummy layer may comprise copper.

The thickness of the dummy layer may range from 7 μm to 35 μm.

A distance between the flexible type unit and the adjacent flexible type unit may be more than 1 mm to less than 4.75 mm.

The flexible type unit may be a tape carrier package or a chip-on-film.

The flexible type reel may further comprise a transfer holes for winding the flexible type reel and an auxiliary dummy layer formed between the transfer holes and the flexible type unit.

The dummy layer and the auxiliary dummy layer may comprise the same material.

The flexible type reel may further comprise a driver connecting to the electrode lines to generate the driving signal.

A method of manufacturing a flexible type reel according to an embodiment of the present invention comprises preparing a film, forming a conductive layer on the film, forming an electrode line by developing the conductive layer, and forming a dummy layer on the film.

The method may further comprise mounting a driver by connecting the driver to the electrode line.

The electrode line and the dummy layer may be formed at the same time by developing the conductive layer.

The method may further comprise forming a transfer holes for transferring the flexible type reel on the film and forming an auxiliary dummy layer between the transfer holes and the flexible type unit.

The flexible type unit may be a tape carrier package or a chip-on-film.

A flexible type unit according to an embodiment of the present invention comprises an electrode lines, formed on the film, for transmitting a driving signal to a display panel, and a dummy layer formed on at least a portion of the film. The flexible type unit may be formed by punching a flexible type reel manufactured by the method claimed in claim 10.

The flexible type unit may further comprise a driver, formed on a film, for generating a driving signal depending on a control signal.

The dummy layer may be non-conductive.

The dummy layer formed on at least a portion of an edge of the film, on which the electrode line is formed, may be non-conductive.

The sum of the thickness of the flexible type unit and the thickness of the dummy layer may ranges from 111 μm to 130 μm.

The dummy layer may be formed on only the edge of the film, on which the electrode line for transmitting the control signal is formed.

The present invention will now be described in detail in connection with specific embodiments with reference to the accompanying drawings.

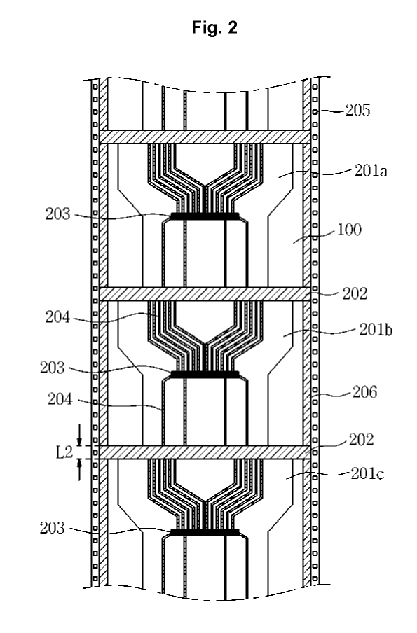

FIG. 2 is a plan view of a flexible type reel according to an embodiment of the present invention. As shown in FIG. 2, a flexible type reel according to an embodiment of the present invention comprises a plurality of flexible type units 201a, 201b and 201c formed on a film 100, for transmitting a driving signal to a display panel, and a dummy layer 202 formed on a film between one flexible type unit 201a and an adjacent flexible type unit 201b.

The flexible type unit 201a comprises a driver 203 formed on the film 100, for generating a driving signal in response to a control signal output from a controller (not shown), and electrode lines 204 formed on the film 100, for transmitting the control signal to the driver 203 and transmitting the driving signal to the display panel.

After a conductive layer is formed on the film 100 of the flexible type reel according to an embodiment of the present invention, patterns of the electrode lines are formed on the conductive layer by a photolithography process. The electrode lines 204 are formed by a developing process. In this case, not only the patterns of the electrode lines but also the pattern of the dummy layer may be formed on the conductive layer formed on the film 100. The electrode lines 204 and the dummy layer 202 may be then formed by a developing process. The driver 203 and the electrode lines 204 are aligned and interconnected to form the flexible type units 201a, 201ba and 201c.

The electrode lines 204 and the dummy layer 202 are formed through the development of the same conductive layer. Therefore, the electrode lines 204 and the dummy layer 202 comprise the same material. For example, in the case where the conductive layer comprises copper, the electrode lines 204 and the dummy layer 202 may comprise copper. The dummy layer 202 may have a thickness of 7 μm to 35 μm.

As described above, the dummy layer 202 is formed on the film 100 between the flexible type unit 201a and the adjacent flexible type unit 201b. Therefore, although the distance between the flexible type unit 201a and the adjacent flexible type unit 201b is narrowed, a phenomenon, such as that the film 100 is torn, is not generated because of an increased strength by the dummy layer 202. It is thus possible to prevent the failure of the flexible type units 201a and 201b when the flexible type unit 201a is separated from the flexible type reel by the punching process.

Furthermore, the dummy layer 202 may be formed using a material different from that of the electrode lines 204. In other words, after the conductive layer is formed on the film, the patterns of the electrode lines are formed on the conductive layer and the electrode lines 204 are formed on the film 100 through the developing process. If the driver 203 is aligned with the electrode lines 204 and is connected to the electrode lines 204, the flexible type units 201a, 201b and 201c are formed. The dummy layer 202 may be formed on the film between one flexible type unit 201a and the adjacent flexible type unit 201b through a screen-printing method or the like. The dummy layer 202 may comprise a conductive material or a non-conductive material.

The flexible type reel according to an embodiment of the present invention may further comprise a plurality of transfer holes 205 formed in the film 100. The flexible type reel according to an embodiment of the present invention may further comprise auxiliary dummy layers 206 formed between the transfer holes 205 and the flexible type units 201a, 201b and 201c. In the same manner as the dummy layer 202, after the conductive layer is formed on the film 100 of the flexible type reel, the patterns of the electrode lines, the pattern of the dummy layer and the patterns of the auxiliary dummy layers are formed on the conductive layer through the photolithography process. The electrode lines 204, the dummy layer 202 and the auxiliary dummy layers 206 are then formed through the developing process. The electrode lines 204, the dummy layer 202 and the auxiliary dummy layers 206 are formed by the development of the same conductive layer. Accordingly, the electrode lines 204, the dummy layer 202 and the auxiliary dummy layers 206 comprise the same material.

Furthermore, the auxiliary dummy layers 206 may be formed using a material different from the electrode lines 204. In other words, after the conductive layer is formed on the film, the patterns of the electrode lines are formed on the conductive layer. The electrode lines 204 are formed on the film 100 through the developing process. If the driver 203 is aligned with the electrode lines 204 and is then connected thereto, the flexible type units 201a, 201b and 201c are formed. The auxiliary dummy layers 202 may be formed on the film between the transfer holes 205 and the flexible type unit 201a through a screen-printing method or the like. The auxiliary dummy layers 206 may comprise a conductive material or a non-conductive material.

To reduce a usage amount of the film 100, the end of the dummy layer 202 and the end of the auxiliary dummy layers 206 may be connected to each other. The flexible type unit 201a, the adjacent flexible type unit 201b and the dummy layer 202 may touch with each other.

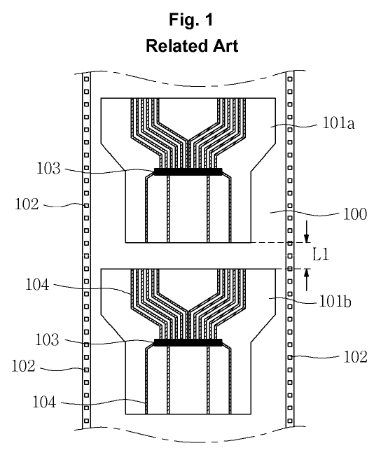

In the general flexible type reel shown in FIG. 1, if the length of the flexible type unit 101a is lengthened by 1 mm, the distance (L1) between the flexible type unit 101a and the adjacent flexible type unit 101b reduces. This increases the possibility that failure may occur. Accordingly, to increase the length of the flexible type unit 101a, it is required to increase the distance (L1) between the flexible type unit 101a and the adjacent flexible type unit 101b. If the distance (L1) between the flexible type unit 101a and the adjacent flexible type unit 101b is increased, the distance between the transfer holes 102 and the transfer holes 102 is 4.75 mm. Therefore, the distance (L1) between the flexible type unit 101a and the adjacent flexible type unit 101b must be increased by 4.75 mm or more. The flexible type reel according to an embodiment of the present invention comprises the dummy layer 202 as shown in FIG. 2. Therefore, the distance (L2) between the flexible type unit 201a and the adjacent flexible type unit 201b in FIG. 2 is smaller than the distance (L1) between the flexible type unit 101a and the adjacent flexible type unit 101b in FIG. 1. Furthermore, the distance (L2) between the flexible type unit 201a and the adjacent flexible type unit 201b may be within a range of 1 mm to 4.75 mm.

The flexible type units 201a, 201b and 201c included in the flexible type reel according to an embodiment of the present invention is the TCP unit or the COF unit.

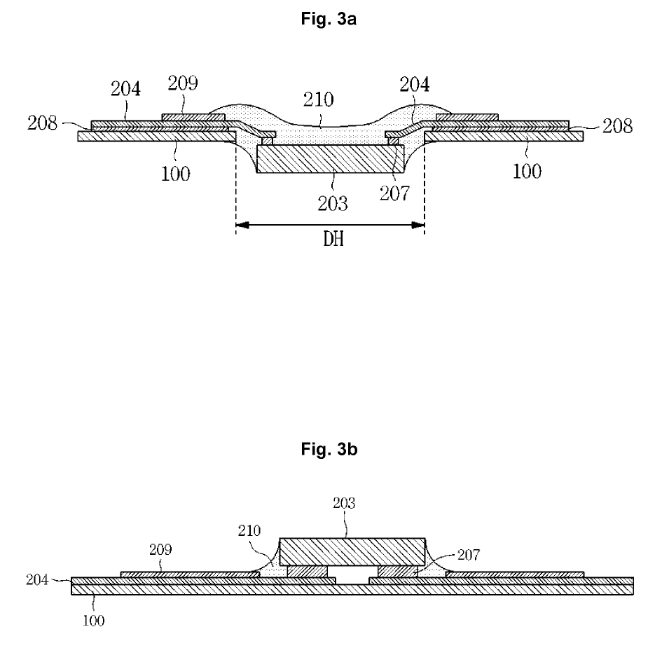

FIG. 3a is a cross-sectional view of the TCP unit included in the flexible type reel according to an embodiment of the present invention. FIG. 3b is a cross-sectional view of the TCP unit included in the flexible type reel according to an embodiment of the present invention.

As shown in FIG. 3a, the TCP unit included in the flexible type reel according to an embodiment of the present invention comprises the driver 203 located in a device hole (DH) region, the electrode lines 204 connected to the driver 203 through a bump 207, the film 204 bonded to the electrode lines 204 by means of a bonding agent 208, a solder resist 209 formed on the electrode lines 204, for preventing the attachment of unnecessary solders, and a sealing resin 210 for fixing the driver 203 and the electrode lines 204. To form the electrode lines 204, the conductive layer is attached on the film 100 by means of the bonding agent 208. After the patterns of the electrode lines 204, the dummy layer 202 and the auxiliary dummy layers 206 of FIG. 2 are formed on the conductive layer, the electrode lines 204, the dummy layer 202 and the auxiliary dummy layers 206 are formed on the film 100 through the developing process.

Furthermore, as shown in FIG. 3b, the COF unit included in the flexible type reel according to an embodiment of the present invention comprises the driver 203, the electrode lines 204 connected to the driver 203 by means of the bump 207, the film 100 bonded to the electrode lines 204, a solder resist 209 formed on the electrode lines 204, for preventing the attachment of unnecessary solders, and a sealing resin 210 for fixing the driver 203 and the electrode lines 204. To form the electrode lines 204 of the COF unit, a conductive layer is formed on the film 100, the patterns of the electrode lines 204 and the dummy layer 202 and the auxiliary dummy layers 206 of FIG. 2 are formed on the conductive layer, and the electrode lines 204, the dummy layer 202 and the auxiliary dummy layers 206 are formed on the film 100 through the developing process, in the same manner as the electrode lines of the TCP unit.

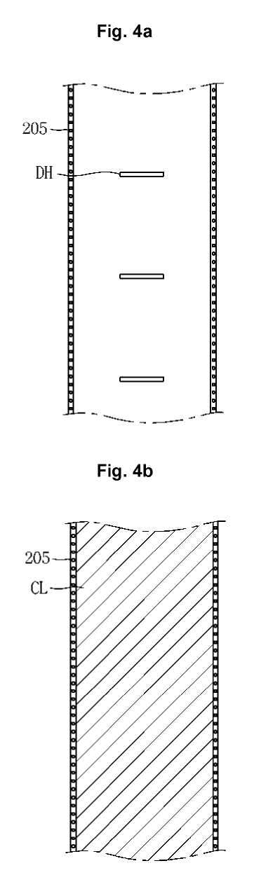

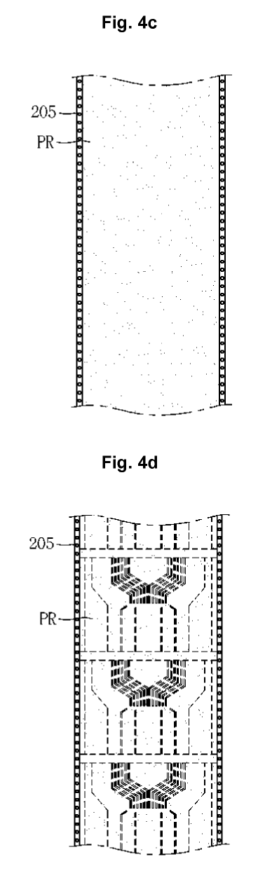

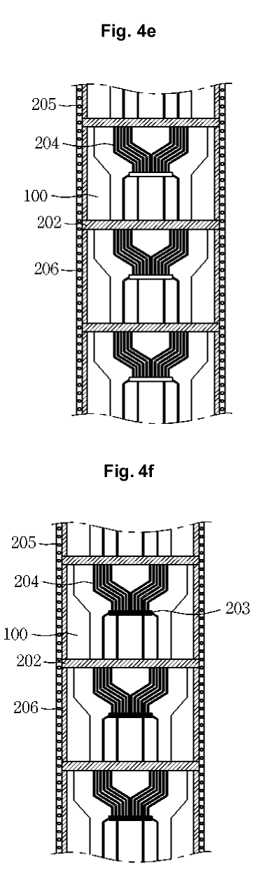

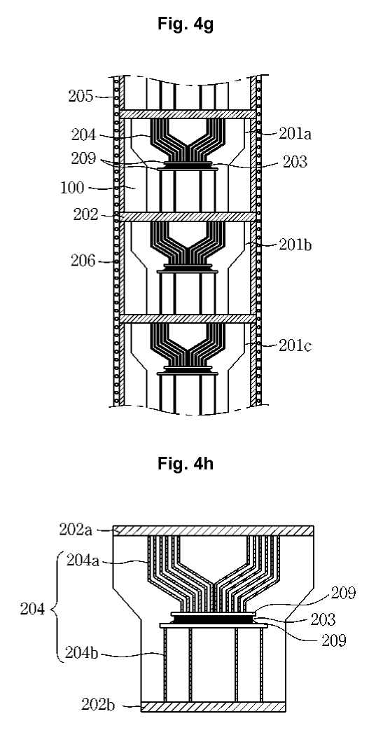

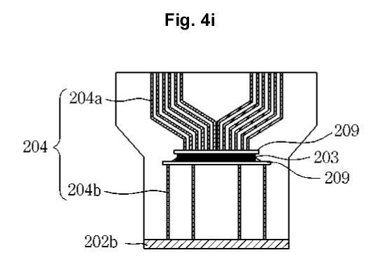

FIGS. 4a to 4i are views illustrating a method of manufacturing the flexible type reel according to an embodiment of the present invention.

As shown in FIG. 4a, the film 100 in which the transfer holes 205 and the device holes (DH) are formed is prepared in order to form the TCP unit. In the case of the COF unit, the device holes (DH) may not be formed in the film 100.

A conductive layer (CL) is formed on the film 100 as shown in FIG. 4b. A photoresist (PR) is coated on the conductive layer (CL) as shown in FIG. 4c.

As shown in FIG. 4d, the patterns of the electrode lines, the dummy layer and the auxiliary dummy layers are formed on the photoresist (PR) by irradiating light onto the photoresist (PR) through a mask in which the patterns of the electrode lines, the dummy layer and the auxiliary dummy layers are formed.

As shown in FIG. 4e, portions other than the patterns of the electrode lines, the dummy layer and the auxiliary dummy layers are removed through the developing process, forming the electrode lines 204, the dummy layers 202 and the auxiliary dummy layers 206.

As shown in FIGS. 4d and 4e, the electrode lines 204, the dummy layers 202 and the auxiliary dummy layers 206 may be formed at the same time. However, after the electrode lines 204 are formed, the dummy layers 202 and the auxiliary dummy layers 206 may be individually formed through the screen-printing method or the like. The dummy layers 202 and the auxiliary dummy layers 206 may be conductive or non-conductive.

As shown in FIG. 4f, after the electrode lines 204 formed through the developing process and the driver 203 are aligned, electrode lines 204 and the driver 203 are connected to each other by means of the bump adhered to the terminal of the driver 203.

As shown in FIG. 4g, the solder resists 209 for preventing the attachment of unnecessary solder after the electrode lines 204 and the driver 203 are connected is adhered on the electrode lines 204. If the sealing resin for fixing the driver 203 and the electrode lines 204 is coated, the flexible type units 201a, 201b and 201c are formed.

As shown in FIG. 4h, flexible type unit 201a is separated from the flexible type reel through the punching process. Portions (e.g., 202a, 202b) of the dummy layers 202 may be connected to at least some of the edge of the film 100 of the separated flexible type unit 201a. In other words, during the punching process, some (202a, 202b) of the dummy layers 202 may be separated from the flexible type reel along with the flexible type unit 201a. The sum of a thickness of the flexible type unit 201a and a thickness of the dummy layers 202 may be in the range of 111 μm to 130 μm.

The electrode lines 204b is connected to the connector (not shown) that transmits a control signal from an external controller (not shown). The electrode lines 204a are connected to the display panel. A portion (202b) of the dummy layers 202 formed on the film 100 in which the electrode lines 204b are formed serves as a latch that facilitates the connection of the connector and the electrode lines 204b. Since some (202a, 202b) of the dummy layers 202 touches the electrode lines 204, some (202a, 202b) of the dummy layers 202 must be non-conductive.

As shown in FIG. 4i, the dummy layers 202b may be formed on the edge of the film 100 in which the electrode lines 204b for transmitting the control signal are formed.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A flexible type reel, comprising:
a plurality of flexible type units, each comprising a conductive layer formed on a film, for transmitting a driving signal to a display panel; and
a dummy layer formed on the film between the flexible type units.

2. The flexible type reel of claim 1, wherein the dummy layer comprises a conductive material.

3. The flexible type reel of claim 2, wherein the dummy layer comprises copper.

4. The flexible type reel of claim 1, wherein the thickness of the dummy layer ranges from 7 μm to 35 μm.

5. The flexible type reel of claim 1, wherein a distance between the flexible type unit and the adjacent flexible type unit is more than 1 mm to less than 4.75 mm.

6. The flexible type reel of claim 1, wherein the flexible type unit is a tape carrier package or a chip-on-film.

7. The flexible type reel of claim 1, further comprising a transfer holes for winding the flexible type reel and an auxiliary dummy layer formed between the transfer holes and the flexible type unit.

8. The flexible type reel of claim 7, wherein the dummy layer and the auxiliary dummy layer comprises the same material.

9. The flexible type reel of claim 1, further comprising a driver connecting to the electrode lines to generate the driving signal.

10. A method of manufacturing a flexible type reel, comprising:
preparing a film;
forming a conductive layer on the film;
forming an electrode line by developing the conductive layer; and
forming a dummy layer on the film.

11. The method of claim 10, further comprising mounting a driver by connecting the driver to the electrode line.

12. The method of claim 10, wherein the electrode line and the dummy layer are formed at the same time by developing the conductive layer.

13. The method of claim 10, further comprising forming a transfer holes for transferring the flexible type reel on the film and forming an auxiliary dummy layer between the transfer holes and the flexible type unit.

14. The method of claim 10, wherein the flexible type unit is a tape carrier package or a chip-on-film.

15. A flexible type unit comprising:
an electrode line, formed on the film, for transmitting a driving signal to a display panel; and
a dummy layer formed on at least a portion of the film,
wherein the flexible type unit is formed by punching a flexible type reel manufactured by the method claimed in claim 10.

16. The flexible type unit of claim 15, further comprising a driver formed on a film, for generating a driving signal in response to a control signal.

17. The flexible type unit of claim 15, wherein the dummy layer is non-conductive.

18. The flexible type unit of claim 15, wherein the dummy layer formed on at least some of an edge of the film, on which the electrode line is formed, is non-conductive.

19. The flexible type unit of claim 15, wherein the sum of a thickness of the flexible type unit and a thickness of the dummy layer ranges from 111 μm to 130 μm.

20. The flexible type unit of claim 15, wherein the dummy layer is formed on only the edge of the film, on which the electrode line for transmitting the control signal is formed.
